(19) United States
(12) Patent Application Publication
(10) Pub. No.: US 2006/0137914 A1
(43) Pub. Date: Jun. 29, 2006

(54) Method and device for measuring the weight applied to the ground by at least one axle

(75) Inventor: Bernard Hodac, Paris (FR)

Correspondence Address: GREER, BURNS & CRAIN, 300 S WACKER DR, 25TH FLOOR, CHICAGO, IL, 60606, US

(73) Assignee: OSMOS S.A.

(21) Appl. No.: 11/020,696

(22) Filed: Dec. 23, 2004

(51) Int. Cl. G01G 19/52; G01M 5/00; G01G 19/03

(52) U.S. Cl. 177/132; 702/175; 73/786

(57) ABSTRACT

A bridge comprises a floor, one end of which embodying a first bearing line rests on a shoulder of an abutment by means of two end bearings. Detectors of vertical dimensional variation are connected to the bearings. When a vehicle crosses the end of the floor, the sudden variation in vertical dimension experienced by the bearings when each axle of the vehicle reaches the end of the floor is detected. These sudden variations are analyzed in order to develop a measurement of the weight transmitted to the ground by each of the axles. The sum of these weights provides a measurement of the total weight of the vehicle. When a pre-determined limit is exceeded, alarms and/or actions are triggered. The invention is useful for simple, economic and systematic checking of the observance of the maximum weights authorized for vehicles crossing a bridge or more generally following a determined route.

The present invention relates to a method for measuring the weight applied to the ground by at least one vehicle axle.

The present invention also relates to a device for measuring the weight applied to the ground by at least one vehicle axle.

The increasing power of commercial road vehicles allows vehicles which are increasingly heavily loaded to travel on the road network in an apparently normal way. This results in an increasing stress on the road infrastructure, and a risk of accelerated ageing or even breakage of certain pieces of equipment. Bridges are particularly exposed to this type of risk.

The authorities currently carry out checks by installing, for example in a parking area, a weighbridge onto which vehicles which the traffic police have intercepted from among the traffic may be driven at very low speed. This method produces precise results but setting it up for a series of inspections is tiresome. For a road haulier, the chances of being stopped while travelling with an excess load are extremely small. Therefore the protection of the road infrastructure is not ensured.

It has also been envisaged to install special carriageway elements which would be sensitive to the stress resulting from the passage of an axle. Even if vehicles were slowed down, the results obtained would be extremely imprecise because the complex deformation of a carriageway element is converted by strain gauges into a signal in the form of a dome which is very difficult to interpret in terms of applied load.

The object of the invention is to propose a method and/or a device which makes it considerably easier to check the weight of road vehicles, and if appropriate implement appropriate measures if an authorized limit is exceeded.

According to a first aspect of the invention, the method for measuring the weight applied to the ground by at least one vehicle axle is characterized by the step of detecting the sudden variation experienced by a vertical dimension of a structure of a bridge beneath an end bearing line embodied by one end of a floor of the bridge when the axle crosses said end bearing line when travelling along the road.

When a vehicle axle passes the first bearing line of a bridge, the weight that the axle applies to the ground is suddenly transferred from an essentially rigid and fixed solid body to a floor of the bridge. When the axle crosses the last bearing line, the weight that it applies to the ground is suddenly transferred from a floor (the same as before or another one) to an essentially rigid and fixed solid body.

The notion of “end bearing lines” must thus be understood as describing the two horizontal transverse lines of the carriageway between which the weight applied by the axles is transferred to the structure of the bridge, which can be deformed relative to the solid bodies between which the bridge extends.

According to the invention, there is taken advantage of the sudden dimensional variation experienced by the subjacent structure at the end of the floor of the bridge when a vehicle axle comes to rest on this end corresponding to the first bearing line of the bridge, or, in the other direction of traffic, when a vehicle axle removes the load from the floor of the bridge when it passes the last bearing line of the bridge.

It was found according to the invention that a remarkably clear display of the load represented by the axle in question was thus available. The floor serves as a means of direct transmission between the axle and the infrastructure supporting the end of the floor. According to the invention, a dimensional variation is directly converted into a measurement of applied load. This differs from the prior art where it was wished to measure a distribution of stress in space and time in order to try to deduce an applied load value from same.

The method according to the invention does not call for vehicles to be slowed down. It can therefore be in constant operation. Consequently, if for example the presence of the measuring system is announced before the bridge, the bridge will probably no longer or practically no longer be crossed by vehicles which are overloaded and/or which exceed the tonnage limit authorized for traffic on the bridge in question.

In order to detect the sudden variation in vertical dimension, a variation in vertical dimension of a bearing interposed between the floor of the bridge and a bridge abutment supporting said end of the floor is preferably detected.

A variation in vertical dimension of a bridge support, in particular a ridge abutment, supporting the end of the floor can also be detected.

When the bearings are of a relatively flexible type, for example of neoprene, the sensitivity can be sufficient if only the variation in vertical dimension of the bearing is detected. On the other hand, in the case of relatively rigid bearings, such as those made of metal, the reduction in height of the bearing when an axle passes over, even when heavily loaded, can be very small. Thus according to the invention it is preferred to detect the variation in vertical dimension along the height of the bridge support, for example over several metres of height beneath the floor. The detection can include at the same time the bearing and some of the height of the bridge supporting such as the abutment.

The method is particularly advantageous if, in order to detect the dimensional variation, a detection method is used with instantaneous appearance and transmission, without dead time, of a detection signal between the detection site at the end of the floor and the processing site. Such a detection method is preferably of the type using the alteration of an optical signal. Optical fibre detectors which make use of the particular property of optical fibres of attenuating transmitted light when they are stretched are envisaged in particular. EP-B 0264 622 describes such a detector which can measure a variation in distance between two points separated by for example several metres. EP-B 0649 000 describes such a detector which is very robust with regard to fatigue stress and capable of detecting very small variations in dimension between two points which can be relatively close, transforming the variations in dimension into bending variations of the optical fibre.

In this type of detector, a constant light power is applied to one end of the fibre and the light power received at the other end constitutes an input signal indicating in real time and without a delay the variations in dimension experienced by the detector.

Thus, according to the invention, the end of the floor immediately and directly experiences the load variation due to the passage of an axle over the first or the last corresponding bearing line, and the immediate dimensional variation which results from it is immediately converted into an input signal for a process of developing measurement signals and/or appropriate control signals and action, in particular when the authorized limits are exceeded. Moreover this absence of dead time between the event and its consequence in terms of detection automatically eliminates the influence of the spurious effects, in particular those which are due to any deformation of the floor and its inertia.

Thus recordings can be made which very precisely relate the variations in dimension experienced by the bridge at said end on the one hand to the time scale on the other hand. It is also provided according to the invention to make a video recording of the vehicular traffic on said end of the bridge, with a time scale using the same clock as the one associated with the above-mentioned recording of the variations in dimension. It is therefore possible, in cases of doubt or a dispute, to ascertain which vehicle caused a determined series of sudden variations in dimension, and to determine whether, during this period, a particular phenomenon was able to disturb the measurement.

In particular when the floor rests on the support by at least two bearings, it is advantageous to detect the dimensional variation at at least two different points of the width of the end of the floor, each point preferably being adjacent to one of the bearings.

Particularly preferably, the dimensional variation is detected by connecting a deflectometer to each bearing of the end of the floor.

For a carriageway with two traffic lanes, the distribution of the dimensional variation on one and the other bearing indicates in which lane the vehicle whose axle is producing the dimensional variation is travelling. This distribution can be used to distinguish between two vehicles travelling more or less side-by-side. An axle of a determined vehicle produces a simultaneous variation on the two bearings but with a distribution which is characteristic of the lane along which this axle is travelling,

The weight applied by the axle can very easily be calculated according to the elastic rigidity of each bearing and the vertical deformation of each bearing. In practice, calibration curves or correspondence laws are preferably used which give the applied load as a function of the detection signal generated by the corresponding vertical deformation of the bearing. Such correspondence laws are established before the device is commissioned. In particular they allow account to be taken of the dynamic effects which can cause the deformation experienced by a bearing during the passage of a moving axle to be greater or smaller than the deformation which would be due to an equal, but immobile, weight on the end of the floor. They also allow account to be taken of any hyperstatic properties of the floor on its bearings.

Different correspondence laws can be provided for different passage speeds. In this case, the method provides for an evaluation of the speed of travel of the axle that produced the sudden dimensional variation. The speed can be assessed from the interval which separates the successive sudden dimensional variations caused by the passage of a vehicle, or by a speed-measuring device, using for example the Doppler effect, placed above the carriageway, or from the slope of the dimensional variation from the high level of the jump corresponding to the sudden dimensional variation which is considered to correspond to the passage of an axle. During the sudden dimensional variation, the high level corresponds to the presence of the axle on the floor and the low level to its absence. From the high level, the axle moves from the end towards the centre of the floor and the stress on the bearing diminishes at a rate (slope of the chronogram of the deformation detection signal) which is a function of the speed at which the vehicle is moving. In the other direction of travel, the stress increases until the axle reaches the end of the floor (last bearing line), at which point the stress due to this axle suddenly disappears.

According to the speed determined for the vehicle, or speed range in which the speed of the vehicle is situated, the appropriate correspondence law is chosen to relate a measured axle weight to a detected sudden dimensional variation.

In some cases, the real correspondence law between the sudden dimensional variation and the axle weight can shift over time. For example, neoprene bearings can become less elastic. It can also happen that the carriageway join between the end of the floor and the carriageway on solid ground deteriorates over time, which can modify the dynamic effect during the passage of the axle. The response curve of the detectors can itself shift over time. It is provided according to the invention to keep, preferably automatically, at least one set of statistics on the weight evaluations carried out. If for example the average recorded weight differs from a pre-determined reference variable by more than a pre-determined value, it is deduced that a recalibration is necessary. Such a recalibration can be carried out automatically as a function of the recorded difference and the direction of this difference.

In a preferred version of the method according to the invention, the series of dimensional variations which are caused by the successive axles of the same vehicle is identified.

The total weight of a vehicle can thus be calculated by adding together the weights applied to the ground by its different axles.

According to a second aspect of the invention, the device for measuring the weight applied to the ground by at least one vehicle axle is characterized in that it comprises:
input means for receiving at least one input signal which is representative of a deformation as a function of time; and
processing means which convert a sudden variation value of the input signal into at least one output which is representative of an at least partial weight applied by a vehicle.

Other features and advantages of the invention will emerge from the description below, which relates to non-limitative examples.

In the attached drawings:

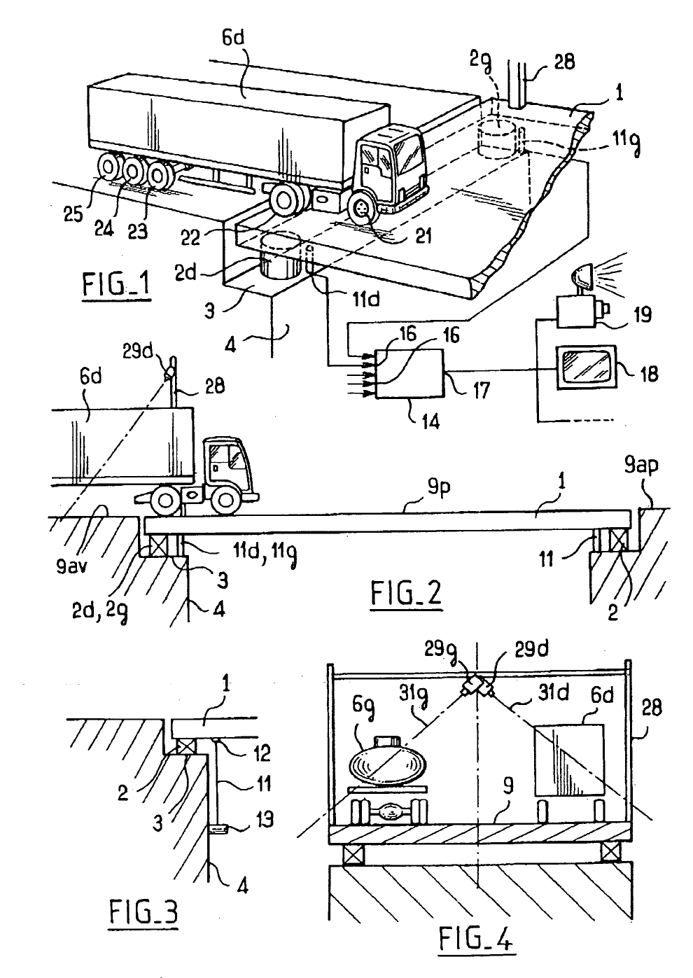

FIG. 1 is a schematic view, partially in exploded perspective, showing a bridge end over which a commercial vehicle is passing;

FIG. 2 is an elevation view of the bridge of FIG. 1, showing part of the measuring device according to the invention;

FIG. 3 is a view of the left end of the bridge of FIG. 2, in a modified embodiment of the device;

FIG. 4 is a cross-sectional view of the end of the bridge showing two vehicles travelling side-by-side in the same direction;

FIG. 5 is a chronogram of the signal detecting the vertical compression of a bearing, as recorded by a detector of the device according to the invention in the situation of FIG. 1;

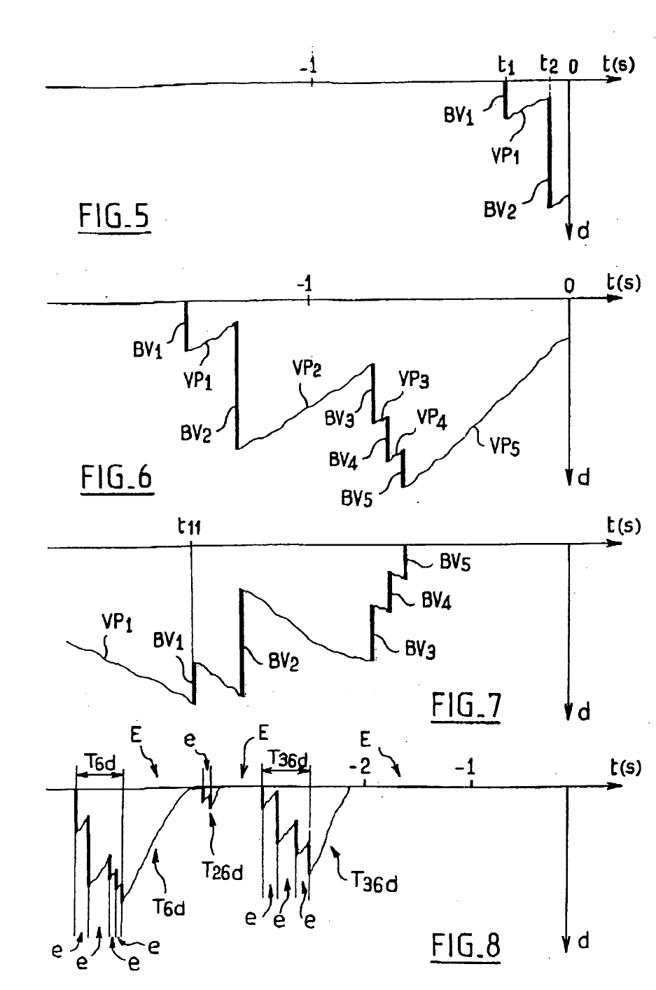

FIG. 6 is a chronogram of the signal detecting the vertical compression once the whole vehicle has passed the first bearing line of the bridge;

FIG. 7 is a chronogram of the signal detecting the vertical compression at the other end (last bearing line) of the floor after this other end is crossed by the same vehicle;

FIG. 8 shows, on a smaller time scale, the chronogram of the series of variations of the detection signals produced by three vehicles that have successively crossed the first bearing line of a bridge;

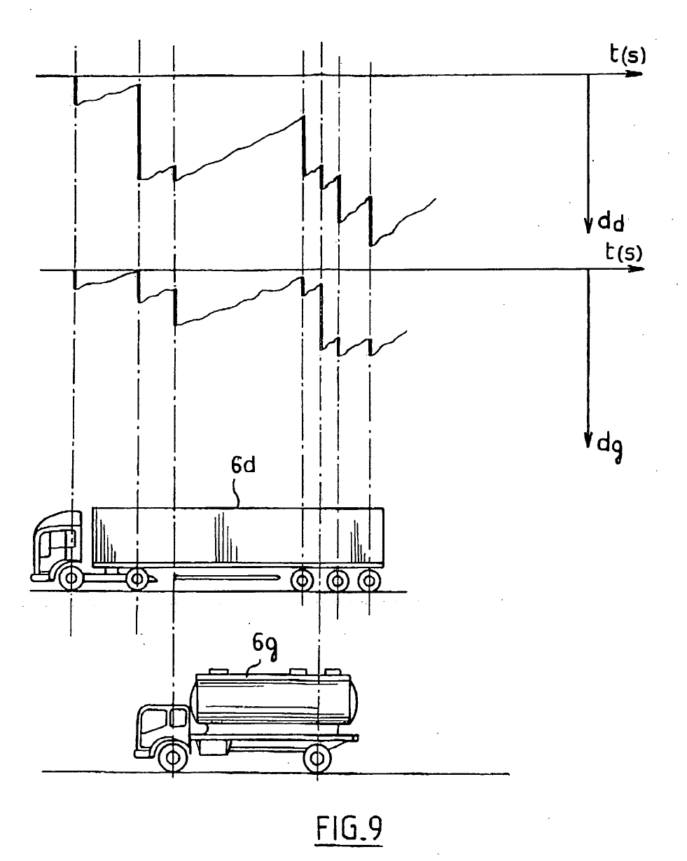

FIG. 9 is a view which combines the two chronograms relating to the signals detecting the compressions of the two bearings of the same end of the floor during the simultaneous passage of two vehicles, one in the left-hand lane and the other in the right-hand lane, respectively; and

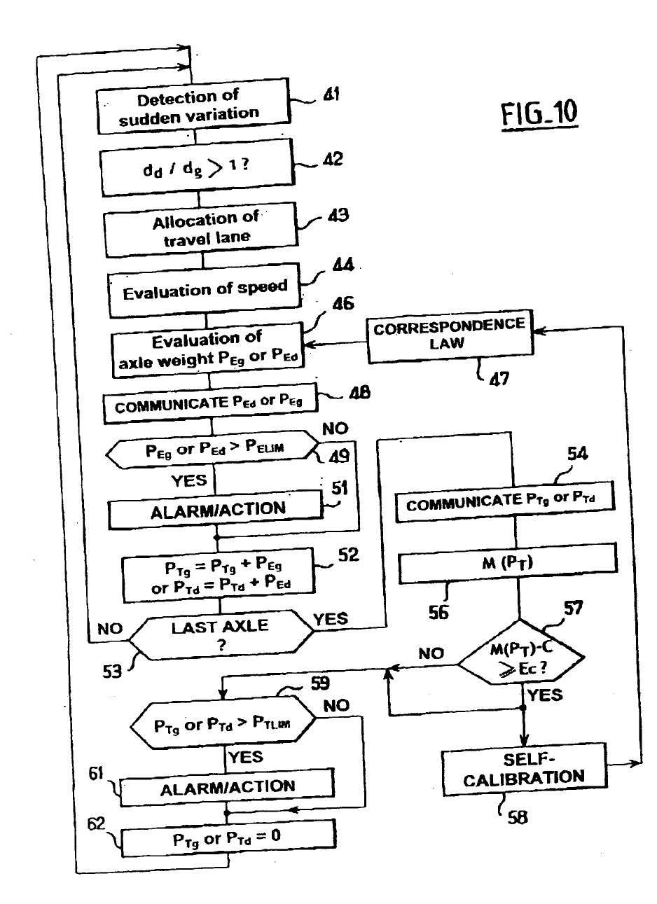

FIG. 10 is an example of a simplified organigram for the processing of the input signals and the development of the control and output signals of the device.

In the example shown in FIGS. 1 and 2, a road bridge comprises a floor 1 the top surface of which is constituted by a carriageway 9d. In the example it is presumed that the carriageway has a width corresponding to two lanes of traffic. Still by way of example, it is presumed that the two lanes are intended for the same direction of traffic. Its dimension measured parallel to the direction of travel is called length of the floor 1, and its horizontal dimension perpendicular to the direction of travel is called width of the floor 1.

At each end of its length, the floor 1 rests by means of two bearings 2 on a shoulder 3 of the bridge abutment. The end of the floor 1 which is crossed first (FIG. 1 and left-hand side of FIG. 2) by a vehicle such as the commercial vehicle 6d, travelling in the intended direction, constitutes the first bearing line of the bridge. More particularly, the bearing situated beneath this first end and close to the right-hand longitudinal edge, relative to the direction of travel, of the floor 1 is numbered 2d. The bearing situated beneath this same end of the floor 1 but close to its left-hand longitudinal edge is numbered 2g. The other end of the floor 1 (right-hand part of FIG. 2) constitutes the last bearing line of the bridge.

Beyond the ends of the floor 1, the carriageway 9p of the floor 1 continues as a carriageway 9av before the bridge and as a carriageway 9ap after the bridge, the carriageways 9av, 9p and 9ap together constituting “the carriageway 9”.

According to the invention, a respective detector has been installed between the under-surface of the floor 1 and the shoulder 3, along each bearing 2. More particularly the detector associated with the bearing 2d is numbered 11d, and the detector associated with the bearing 2g is numbered 11g (FIG. 1). Each detector 11 is for example in accordance with EP 0 649 000, and in particular is of a type converting a dimensional variation into a modulation of the light power restituted by an optical fibre. The detectors 11 are installed so as to detect the variations experienced by the vertical dimension of the bearings 2 with which they are respectively associated.

In the variant represented in FIG. 3, which relates more particularly to the case of very stiff bearings 2, the detector 11 is an optical line prestressed in extension, for example according to EP 0 264 622, arranged vertically over several metres of height between an anchor 12 at the under-surface of the floor 1 and an anchor 13 in the front surface of the abutment 4 of the bridge. With this assembly, the detected deformation in vertical compression covers the compression of the bearing 2 and the compression of the abutment between the shoulder 3 and a horizontal plane passing through the anchor 13. An increase in the vertical compression produces a reduction of the extension prestressing of the optical fibre and therefore an increase in the light power restituted by the optical fibre.

The device according to the invention comprises a processing unit 14 comprising inputs 16 for receiving the signals coming from the detectors such as 11d, 11g, and one or more outputs 17 connected to a video screen 18 displaying measurements, to a camera with a flashlight 19 for photographing vehicles breaking the law, or the like, such as audible or visual alarms, automatic closure of a barrier, etc.

The processing unit 14 comprises means for developing, from the signals received at the inputs 16, one or more signals at the output 17 which are representative of the weights transmitted to the carriageway by the vehicles crossing the end of the bridge.

FIG. 5 is a chronogram of the signals representative of the dimensional variations recorded by one of the detectors 11d or 11g, for example the detector 11d, in the situation represented in FIG. 1.

The time-point when the wheels of the front axle 21 of the vehicle 6d have crossed the first bearing line and come to rest on the floor 1 is called t₁. It is presumed that before time-point t₁ the recorded compression was mil, i.e. there is taken as the origin of the deformations the state of compression of the bearing 2 of the floor 1 under the weight of the floor 1 when there is no vehicle on the floor 1.

When the axle 21 comes to rest this causes a sudden dimensional variation designated BV1. In theory, this variation in deformation is equal to:
Q·P_{B21}/K

in this expression:

Q is a factor, between 0 and 1, representing the fraction of the weight of the axle which bears on the bearing considered;

P_{B21} is the weight of the vehicle which is transmitted to the ground by the axle 21; and

K is the elastic constant of the bearing 2 considered.

If the variations in deformation of the two bearings 2d and 2g are measured at the same time, these two deformations can be added together and the total deformation can then be considered equal to:
P_{B21}/K

Knowing K on the one hand, and on the other hand the correspondence law between the levels at the signal and the levels of deformation of the bearings, this formula allows direct determination of the weight P_{B21} in a theoretical way.

The above calculations presume that the floor 1 rests isostatically on the two bearings 2d and 2g. Moreover their use requires, in most cases, calibrations relating to the value of K for the two bearings 2d and 2g and relating to the response of each of the two detectors 11d and 11g to a given dimensional variation. Moreover, the calculation is accurate only if the value of K is the same for the two bearings, and if the dynamic effects are negligible.

This is why it is preferred, according to the invention, to undertake a prior calibration in order to establish at least one correspondence law between each axle weight and the detection signals which take account of the corresponding deformations on the two bearings, when the vehicle is in the right-hand lane and when the vehicle is in the left-hand lane. In other words, according to the invention, it is preferred to pass directly from the detection signals, for example a variation in the restituted light power, to an evaluation of weight, without necessarily seeking to learn either the real deformation or especially the corresponding real stress.

It is also preferred according to the invention to establish a different correspondence law for each of several speed ranges at which the vehicle crosses the end of the floor 1.

Thus, either in a more or less theoretical way or preferably on the basis of a prior calibration, the amplitude of the sudden variation BV₁ of the signal allows evaluation of a weight transmitted to the ground by the front axle 21 of the vehicle.

Then, as is shown in FIG. 5, the deformation experiences a phase of progressive decrease VP₁ which corresponds to the fact that front axle 21 is moving away from the end of the floor 1 towards the other end of the floor 1. The slope of this phase of progressive decrease is more or less proportional to the speed at which the vehicle is travelling. This slope therefore constitutes an indication of the speed at which the vehicle is travelling and this indication allows selection of the correspondence law between the sudden dimensional variations such as BV₁ and the axle weights when several correspondence laws each associated with a range of speeds of travel have been previously established.

At time-point t₂, the rear axle 22 of the lorry of the lorry-trailer combination 6d comes in turn to rest on the end of the floor 1 and this results in a fresh sudden variation BV₂ (FIG. 5) in the direction of the increase in the level of compression of the bearing.

FIG. 6 represents the situation a few moments later, when all of the lorry-trailer combination 6d is on the floor 1. The three rear axles of the trailer 23, 24, 25 have each successively created sudden dimensional variations BV₃, BV₄, BV₅. Like the sudden variation BV₁, each of the sudden variations BV₂, BV₃, BV₄, BV₅ is followed by a progressive decrease VP₂, VP₃, VP₄, VP₅.

The signal thus collected for the whole vehicle comprises as characteristic elements, independent for example of the vehicle speed, the number of sudden variations, the respective amplitude of each of the sudden variations and their relative spacings parallel to the time axis of the chronogram. This set of characteristics of the signal generated by the passage of the vehicle is called a vehicle signature. This signature allows identification of the type of vehicle and consequently allows reference to be made to the maximum authorized gross vehicle weight for this type of vehicle.

Moreover, as is shown in FIG. 7, when the same vehicle arrives at the other end of the floor 1, a progressive dimensional variation VP₁, is observed as the axle 21 approaches the last bearing line and progressively loads the corresponding end of the floor 1 until, at the time-point t₁₁, the front axle 21 leaves the floor 1 and suddenly removes the load from said corresponding end of the latter. This results in a sudden dimensional variation BV₁, which is theoretically in an equality relationship (or other if the correspondence law is different) with the variation BV₁ of FIG. 6, but occurs in the opposite direction. Thus decreasing sudden variations BV₂, BV₃, BV₄, BV₅ will be observed, theoretically of the same amplitude as (or of an amplitude which is for example proportional to) those of FIG. 6, and with the same time intervals between them if the vehicle speed has not varied, or with time intervals proportional to those of FIG. 6 if the vehicle speed has varied. When the last axle 25 leaves the floor 1, the dimensional variation recorded by the detector(s) returns to level 0 corresponding to the resting of the floor 1 on its bearings 2.

It is provided according to the invention that the processing unit 14 which has recorded the vehicle's signature when it enters the floor 1 (FIG. 6) then recognizes this signature when the vehicle leaves the floor 1 (FIG. 7), compares the weights measured for each axle in both cases and produces a refined weight measurement. For example, the processing unit 14 takes as refined measurement of the weight applied by an axle the smaller of the two measured values, or the more likely or the more usable of the two measurements.

If for example one of the two measurements has been disturbed by the simultaneous presence of another vehicle, for example if an axle of one of the vehicles has crossed one of the end bearing lines of the bridge at exactly the same time as an axle of the other vehicle, the signature of a vehicle with n axles is then constituted by the n-1 sudden variations which are not disturbed. For the n-th axle, that measurement of the two which is not disturbed is used.

FIG. 8 shows on a more restricted time scale the sudden variations generated by three successive vehicles, namely the series T6d generated by the vehicle 6d, a series T26d generated by a private vehicle or a light commercial vehicle, and a series T36d generated by a second heavy commercial vehicle having a different signature from the vehicle 6d.

The analysis of this succession of signals allows determination of the time intervals corresponding to the series T6d, T26d, T35d, during which sudden variations occur with a time difference “e” between them which is variable but which never exceeds a relatively small determined value. The processing device interprets each period during which sudden variations occur separated by such small time intervals as corresponding to the period of crossing of the same vehicle, respectively. Between these periods, the processing device detects longer intervals of time E corresponding to spaces between vehicles. According to the evaluation of the speed of travel of the vehicles, obtained for example from the slope of the progressively variable parts VP of each series of signals, or by a measuring device working above the carriageway, the processing unit chooses a duration threshold between successive sudden variations beyond which it considers that there are two separate vehicles. And in particular this threshold is given a value which decreases when the speed of travel increases. Thus, the maximum distance between two successive axles considered as belonging to the same vehicle can be made constant and independent of the speed of travel of the vehicles.

When the speed of travel decreases and reaches very low values (in the case of a traffic jam), it is common for the vehicles to follow each other very closely and the distance between the last axle of a vehicle and the first axle of the one following it can even become smaller than the maximum possible distance between two successive axles of the same vehicle. In this case, it is necessary to either not measure the total weight of each vehicle, and measure only its weight applied to the ground for each axle, or to use other means to distinguish the sudden variations which can be associated with each vehicle. It is also possible that even when the speed of travel is higher the progressively variable parts VP of the signal are too distorted to allow an evaluation of the speed overall.

In order to remedy all of this, according to the invention means for detection of presence are proposed which have a field of action above the carriageway 9.

To this end, in FIG. 4 and in part in FIGS. 1 and 2 a gantry 28 has been shown arranged above the end of the floor 1 and carrying, in the centre of its transverse bar, some metres above the longitudinal axis of the carriageway 9, two presence detectors 29d and 29g whose axes of detection are orientated one towards the left-hand longitudinal edge of the carriageway, the other towards the right-hand longitudinal edge of the carriageway, both downwards and (FIG. 2) rearwards. The axis of detection 31d of the detector 29d is crossed by the vehicle 6d travelling in the right-hand lane while the axis 31g of the detector 29 g is crossed by a vehicle 6g (FIG. 4) travelling in the left-hand lane. Thanks to the rearward inclination, (FIG. 2), very small differences such as for example between the cabin of the lorry of a vehicle such as 6d and the semi-trailer coupled to this lorry are not detected and are therefore not interpreted as an interval between two different vehicles. A forward inclination, relative to the direction of travel, would produce the same result. The result of the detection can be sent to the processing unit 14 by a third of the inputs 16. When the axis of detection 31 of a detector is not cut, the processing unit 14 thinks that there is an interval between two successive vehicles. Consequently, the processing unit 14 attributes to the same vehicle, subject to the means which will be described below for distinguishing between vehicles travelling side-by-side on the two lanes of the carriageway 9, the sudden variations of stress/deformation which succeed each other without being interrupted by an interval between vehicles.

The means for distinguishing between two vehicles travelling side-by-side will now be described with reference to FIG. 9. FIG. 9 represents one above the other the vehicles 6d and 6g in their relative positions as regards longitudinal direction. The graph d_{d} shows the variations in stress/deformations recorded by the right-hand detector 11d and the graph d_{g} the variations in stress/deformations recorded by the left-hand detector 11g. Because the vehicle 6d is travelling in the right-hand lane, its weight bears principally on the right-hand bearing 2d, while the weight of the vehicle 6g travelling in the left-hand lane bears principally on the left-hand bearing 2g. Each axle passage produces a sudden simultaneous variation on the two detectors 11d and 11_{g}. However, when the axle producing the sudden variation belongs to the right-hand vehicle 6d, the sudden variation recorded is stronger on the graph d_{d} than on the graph d_{g}. On the other hand, when the axle belongs to the left-hand vehicle 6g, the sudden variation is stronger on the graph d_{g}, than on the graph d_{d}. The processing unit therefore allocates to one or other vehicle each axle and the associated weight as a function of a comparison between the sudden variation detected by the detector 11g and that detected by the detector 11d.

In FIG. 10 a schematic organigram is shown which can be used in the processing unit 14.

In a step 41, the presence of a sudden variation in the signals arriving via the inputs 16 is detected.

The step 42 involves ascertaining whether the sudden variation detected is stronger on the bearing 2d or on the bearing 2g, in order to determine the traffic lane used by the vehicle whose axle has produced the sudden variation (step 43).

In a step 44, the speed of travel of the vehicle is determined, for example by a device, using the Doppler effect, which has a field of action above the carriageway.

In step 46 the weight applied by the axle is determined by selecting from a memory 47 for the correspondence laws the law corresponding to the speed evaluated in step 44. The weight applied by an axle travelling in the left-hand lane is called P_{Eg} and the weight applied by an axle travelling in the right-hand lane is called P_{Ed}. The determination takes into account the two signals d_{d} and d_{g}. The two loads corresponding to the two sudden variations respectively can for example be added together if there is a correspondence law for each bearing. By way of a variant, for each speed range there can be a single, but more complex correspondence law, giving a weight for each combination of two sudden-variation values on the two detectors.

In step 48, the evaluated weight P_{Ed} or P_{Eg} is communicated so that it is displayed on the screen 18 of FIG. 1.

In step 49, a test determines whether the weight calculated for the axle exceeds a pre-determined limit P_{ELIM}. If it does, an “alarm/action” step is carried out consisting for example of triggering the picture-taking apparatus 19. If it does not, or after step 51 if it does, a step 52 adds the axle weight P_{Eg} or P_{Ed} to the value of a parameter P_{Tg} or P_{Td} respectively representative of the total weight of the vehicle which is crossing the end of the floor.

Then, a test 53 determines whether the axle whose weight has just been evaluated is the last axle of the vehicle. For this, one of the methods described above is used. If it is not, return to step 41 to wait for the following axle.

If, on the other hand, the axle which has just been measured is the last of the vehicle, proceed to a step 54 to communicate the total weight P_{Tg} or P_{Td} of the vehicle, for example for display on the screen 18.

A step 56 calculates the new average (M(P_{T})) of the total weights of the vehicles which have crossed the bridge for example in the last three months.

A test 57 checks whether the new average differs, compared with a reference variable C by an amount that is larger than or equal to a pre-determined value Ec. If it does, the conclusion is that there has probably been a shifting of the device and a step of self-calibration 58 is initiated which modifies the correspondence laws contained in the memory 47. In addition, join the negative output of the test 57 and proceed to another test 59 which checks whether the total weight P_{Tg} or P_{Td} exceeds a total-weight limit P_{TLIM} authorized on the bridge. If it does, an “alarm/action” step 62 is carried out, consisting for example of an activation of the picture-taking apparatus 19. If the weight limit P_{TLIM} is not exceeded, or after step 61 if it is exceeded, the parameter P_{Tg} or P_{Td} is set equal to zero; return to step 41 to wait for the following sudden variation.

Of course, the invention is not limited to the examples described and represented.

For example, the speed of travel of the vehicles could be evaluated from the period between two sudden variations belonging to the same variation series. In the software, if the vehicle speed is determined by the analysis of particular properties of the series of dimensional variations, the development of the measurement must be slightly delayed relative to the acquisition of the detection signal.

Generally, the invention can be credited with having discovered that the end of the floor of a bridge can serve as a means for direct transmission of the vertical stresses between a vehicle axle and a load-bearing structure which the invention uses as a dynamometer. Within the meaning of a bridge, the invention also covers structures constituted by a very short floor installed on bearings above a hollowed-out part of the subjacent infrastructure with the sole objective of measuring the weight of travelling vehicles. It is also within the scope of the invention to mount the device on a structure of the bridge type situated in front of a more fragile structure in order that overloaded vehicles can be intercepted before reaching the more fragile structure. It is also within the scope of the invention to fit a device according to the invention to several structures situated on various possible routes between two sites in order to prevent overloaded vehicles from making detours to avoid a thus-fitted bridge.

Within the meaning of the invention, the measurement of weight can consist of a single binary signal the low level of which corresponds to a weight which conforms to the regulations and the high level to a weight exceeding an authorized limit.

1. A method for measuring the weight applied to the ground by at least one axle of a vehicle characterized by the step of detecting the sudden dimensional variation experienced by a vertical dimension of a structure of a bridge beneath an end bearing line embodied by one end of a floor of the bridge, this sudden variation being produced when the axle crosses said end bearing line when travelling along the road.

2. A method according to claim 1, characterized in that in order to detect the dimensional variation a variation in vertical dimension of a bearing interposed between the floor of the bridge and a bridge abutment supporting the end of the floor is detected.

3. A method according to claim 1, characterized in that a variation in vertical dimension of a bridge support, in particular a bridge abutment, supporting the end of the floor is detected.

4. A method according to claim 1, characterized in that in order to detect the dimensional variation a detection method is used which uses an instantaneous appearance and transmission of a detection signal between a detection site at the end of the floor and a site for processing the signal.

5. A method according to claim 4, characterized in that said detection method uses the alteration of a light signal.

6. A method according to claim 1, characterized in that the dimensional variation is detected at at least two different points of a width of a carriageway (9) along the end bearing line.

7. A method according to claim 6, characterized in that the dimensional variation is detected by connecting a deflectometer (11d, 11g) to each bearing of the floor end embodying the end bearing line.

8. A method according to claim 6, characterized in that the presence of two vehicles travelling side-by-side is detected from a different distribution of the sudden dimensional variation produced by respective axles of said vehicles at one and the other detection site, respectively.

9. A method according to claim 1, characterized in that the presence of two vehicles travelling side-by-side is detected above the carriageway.

10. A method according to claim 1, characterized in that a passage speed of the vehicle is determined by analysis of a signal representative of the dimensional variation.

11. A method according to claim 10, characterized in that the vehicle speed is evaluated from a period between successive sudden dimensional variations.

12. A method according to claim 10, characterized in that the vehicle speed is evaluated from a slope of a chronogram of the dimensional variation signal created by a progress of the axle on the floor zone adjacent said end of the floor.

13. A method according to claim 1, characterized in that on the basis of a prior calibration the weight measurement is corrected as a function of a speed of the vehicle.

14. A method according to claim 1, characterized by an automatic recalibration of a correspondence law between a signal which is received representing the sudden dimensional variation and an output which is produced representing the weight measurement.

15. A method according to claim 14, characterized in that at least one set of statistics relating to the successive measurements carried out is established, and the recalibration is carried out as a function of the difference between the set of statistics and a reference variable.

16. A method according to claim 1, characterized by a step of identifying series of dimensional variations as being caused by successive axles of a same vehicle.

17. A method according to claim 16, characterized in that a sufficiently large time interval without sudden dimensional variation is identified as corresponding to an interval between two successive vehicles.

18. A method according to claim 17, characterized in that a time threshold beyond which a time interval is considered to be sufficiently large is varied as a function of an estimated vehicle speed.

19. A method according to claim 16, characterized in that, using detection means having a field of detection above the carriageway, the presence of a vehicle is detected above said end of the floor and for the identification step the variations in stress having their origin in a traffic lane are attributed to a same vehicle while presence of said same vehicle is detected there.

20. A method according to claim 16, characterized in that a total weight of the vehicle is measured by additively processing values each obtained in response to one of the sudden dimensional variations of the series.

21. A method according to claim 16, characterized in that:
at a first bearing line on the bridge, a signature of a vehicle reaching the bridge is recorded, made up of elements characteristic of dimensional variations caused by the passage of successive axles of the vehicle;
at a last bearing line on the bridge, the passage of the same vehicle is detected from a corresponding signature;
the detections carried out at the two bearing lines are taken into account in order to develop a refined measurement of the weight applied by each axle.

22. A device for measuring the weight applied to the ground by at least one axle of a vehicle, characterized by comprising:
input means for receiving at least one input signal representative of a dimensional variation as a function of time; and
processing means which convert a sudden-variation value of the input signal into at least one output representative of an at least partial weight applied by a vehicle.

23. A measurement device according to claim 22, characterized in that the device comprises associating means for associating several sudden variations with a same vehicle, means for adding together weights applied by successive axles of a same vehicle, and means for providing at least one output representative of the total weight of a vehicle.

24. A measuring device according to claim 23, characterized in that the associating means comprise means for analyzing the input signal between the sudden variations.

25. A measuring device according to claim 24, characterized in that the analysis means take into account periods between sudden variations.

26. A measuring device according to claim 24, characterized in that the associating means take into account signal slopes between sudden variations.

27. A measuring device according to claim 23, characterized in that the associating means comprise presence-detection means which are intended to be installed in order to have a field of action above the carriageway.

28. A measuring device according to claim 22, characterized in that the at least one representative output comprises a binary signal, and the device comprises alarm and/or action means which are sensitive at one of the levels of the binary signal.

29. A measuring device according to claim 22, characterized in that the input means receive at least two input signals and the processing means take account of simultaneous sudden variations of the two input signals in order to evaluate a weight applied by an axle.

30. A measuring device according to claim 29, characterized in that the processing means develop signals representative of the respective weights of two vehicles that are substantially simultaneous by forming two sums in each of which the values corresponding to the sudden variations which are distributed in substantially a same proportion between the two input signals are added together.

31. A measuring device according to claim 22, characterized by comprising self-calibration means.

32. A measuring device according to claim 31, characterized in that the self-calibration means modify a correspondence law where a difference between a set of statistics relating to the recorded weights and a pre-determined reference variable exceeds a pre-determined value.
